(19) United States
(12) Patent Application Publication
(10) Pub. No.: US 2025/0200487 A1
(43) Pub. Date: Jun. 19, 2025

(54) TERMINAL, SERVER AND METHOD OF MANAGING QUALITY OF VEHICLE

(71) Applicants: Hyundai Motor Company, Seoul (KR); Kia Corporation, Seoul (KR)

(72) Inventor: Chan Young Kim, Hwaseong-si (KR)

(21) Appl. No.: 18/667,175

(22) Filed: May 17, 2024

(30) Foreign Application Priority Data
Dec. 14, 2023 (KR) 10-2023-0181710

(51) Int. Cl. G06Q 10/0639; B62D 65/00; G06Q 50/04

(52) U.S. Cl. CPC G06Q 10/06395; B62D 65/005; G06Q 50/04

(57) ABSTRACT

A terminal system for managing vehicle quality, including one or more terminals, wherein each terminal can include one or more processors, and a storage medium storing computer-readable instructions that, when executed by the one or more processors, enable the one or more processors to generate a display for an inspection item according to a given process for managing vehicle quality, receive data corresponding to the display of the inspection item, and transmit externally a process name of the given process for managing vehicle quality, and the data of the inspection item, and an identification name of a vehicle, wherein each of the one or more terminals has specifications depending on characteristics of the given process for managing vehicle quality.

### CROSS-REFERENCE TO RELATED APPLICATIONS

This application claims benefit of priority to Korean Patent Application No. 10-2023-0181710 filed on Dec. 14, 2023, in the Korean Intellectual Property Office, the disclosure of which is incorporated herein by reference in its entirety.

### TECHNICAL FIELD

The present disclosure relates to a terminal, server, and method for managing vehicle quality.

### BACKGROUND

In general, in a manufacturing process of a vehicle, various structural parts such as a vehicle body panel, formed by a press, by welding, or the like, to complete the entire vehicle body, and painting and rust prevention operations may be performed on a surface of respective components during the painting process for the completed vehicle body.

Next, components of a transmission system and parts such as suspension, steering, and braking systems are assembled (assembly process), followed by an assembly process to assemble doors, a trunk lid, a hood, and the like.

A vehicle at this stage of assembly completion is transported to an inspection line of a vehicle for various inspections, and the vehicle is inspected using various types of inspection equipment installed on the inspection line of the vehicle.

Previously, for vehicle inspection, data (as to whether defects had occurred) was manually entered for each inspection item on paper with various inspection items printed on the paper. This method requires operators to scan pieces of data one by one and convert the data into electronic documents, which takes a considerable amount of time.

As another method to solve this problem, an electronic pen and paper formed of a special material were used. Data may be entered for each inspection item using an electronic pen on a special material paper on which various inspection items are printed, and then when the data is recognized through a camera installed at the tip of the electronic pen, the input data is transmitted to a server through Bluetooth communication.

However, a recognition rate of the electronic pen is very low, and maintenance is difficult due to lack of durability. In addition, Bluetooth communication has a very limited transmission distance, and intermittent disconnections occur, which makes communication unstable and has low security.

### SUMMARY

The present disclosure relates to a terminal, server, and method for managing vehicle quality.

An embodiment of the present disclosure can provide a terminal, server, and method for managing vehicle quality that can solve the problem of a lower recognition rate, and at the same time, make a system easy to be maintained, and improve work efficiency by considering the characteristics of the process for managing vehicle quality as compared to the existing method of using an electronic pen and paper made of a special material.

An embodiment of the present disclosure can provide a terminal, server, and method for managing vehicle quality that can improve communication stability and security by using a private LTE network, check history when defects occur, and improve a sense of operator responsibility.

An embodiment of the present disclosure can provided a terminal, server, and/or method for managing vehicle quality that can prevent a defective vehicle from being shipped.

According to an embodiment of the present disclosure, a terminal for managing vehicle quality can include one or more processors and a storage medium storing computer-readable instructions, where when the computer-readable instructions are executed by the one or more processors, the one or more processors can be configured to display an inspection item according to a process for managing vehicle quality, receive data of the displayed inspection items, and transmit a process name of the process for managing quality, the data of the inspection item, and an identification name of a vehicle externally, where the terminal can have different specifications depending on the characteristics of the process for managing vehicle quality.

According to an embodiment of the present disclosure, a server for managing vehicle quality is provided can include one or more processors and a storage medium storing computer-readable instructions, where when the computer-readable instructions are executed by the one or more processors, the one or more processors can be configured to receive a process name of a process for managing vehicle quality, data of an inspection item according to the process for managing vehicle quality, and an identification number of the vehicle from a terminal, store the received process name of the process for managing vehicle quality, the data of the inspection item, and the identification number of the vehicle, and transmit the process name of the process for managing vehicle quality, the data of the inspection item, and the identification number of the vehicle to a terminal for performing another process for managing vehicle quality other than the current process for managing vehicle quality, where the terminal can have different specifications depending on the characteristics of the process for managing vehicle quality.

According to an embodiment of the present disclosure, a method for managing vehicle quality can include a first operation of displaying, on a terminal, an inspection item according to a process for managing vehicle quality and receiving data of the displayed inspection item; a second operation of transmitting, from the terminal, the process name of the process for managing vehicle quality, the data of the inspection item, and an identification number of a vehicle to a server; a third operation of storing, in the server, the process name of the process for managing vehicle quality, the data of the inspection item, and the identification number of the vehicle, transmitted from the terminal; a fourth operation of transmitting, from the server, the process name of the process for managing vehicle quality, the data of the inspection item, and the identification number of the vehicle to a terminal for performing another process for managing vehicle quality other than the current process for managing vehicle quality; and a fifth operation of updating, in the terminal for performing another process for managing vehicle quality other than the current process for managing vehicle quality, data of an inspection item according to the current process for managing vehicle quality based on the data of the inspection item, where the terminal can have different specifications depending on the characteristics of the process for managing vehicle quality.

According to an embodiment of the present disclosure, a computer-readable storage medium can be provided in which a program for executing the method on a computer can be recorded.

### BRIEF DESCRIPTION OF THE DRAWINGS

The above and other embodiments, features, and advantages of the present disclosure can be more clearly understood from the following detailed description, taken in conjunction with the accompanying drawings, in which:

FIG. 1 is a diagram illustrating a system for managing vehicle quality according to an embodiment of the present disclosure;

FIG. 2 is a block diagram of a terminal and a server according to an embodiment of the present disclosure;

FIG. 3A to 3C are diagrams illustrating terminals of various sizes according to an embodiment of the present disclosure;

FIG. 4 is a diagram illustrating an inspection item for manually inputting data according to an embodiment of the present disclosure;

FIG. 5 is a diagram illustrating an inspection item into which data is automatically input according to an embodiment of the present disclosure;

FIG. 6 is a flowchart explaining a method for managing vehicle quality according to an embodiment of the present disclosure; and

FIG. 7 is a block diagram of a computing device for fully or partially implementing a terminal and/or a server according to an embodiment of the present disclosure.

### DETAILED DESCRIPTION OF ILLUSTRATIVE EMBODIMENTS

Hereinafter, the present disclosure will be described with reference to specific example embodiments and the attached drawings. Some embodiments of the present disclosure may, however, be exemplified in many different forms and cannot be construed as being limited to the specific example embodiments set forth herein.

In describing the example embodiments of the present disclosure, if it is determined that the detailed description of the known technology related to the present disclosure may unnecessarily obscure the subject matter of the present disclosure, the detailed description thereof can be omitted. Terms to be described later can be terms defined in consideration of functions in the present disclosure, which may vary according to an embodiment or custom of a user or operator. Therefore, a definition can be made based on the contents throughout this specification. Terminology used in the detailed description can be merely for describing the example embodiments of the present disclosure and are not necessarily limiting. Unless expressly used otherwise, singular forms of expression can include plural forms. In this description, expressions such as “comprising” or “comprising” are intended to indicate any characteristic, number, step, operation, element, portion, or combination thereof, one or more other than those described, and not to be construed to exclude the existence or possibility of any other feature, number, step, operation, element, part, or a combination thereof.

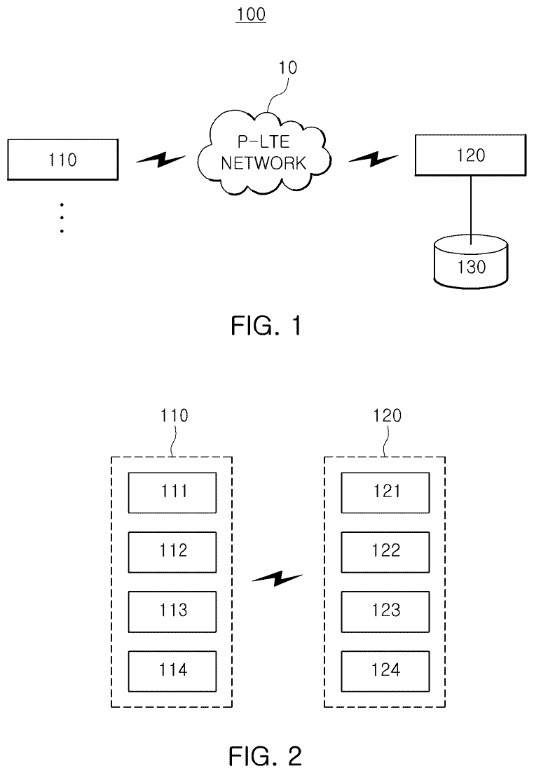

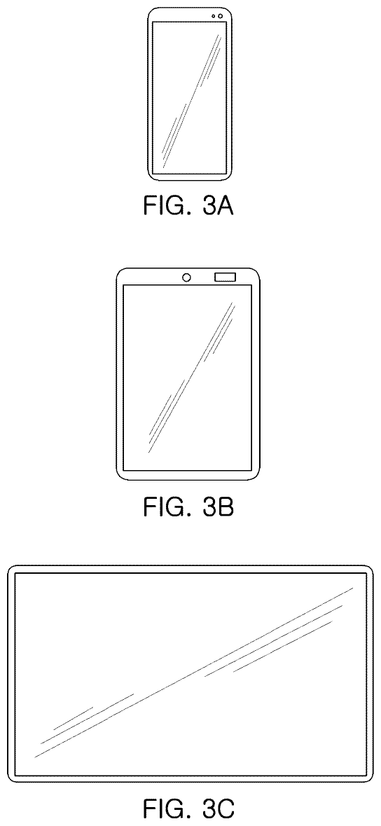

FIG. 1 is a diagram illustrating a system for managing vehicle quality according to an embodiment of the present disclosure. FIG. 2 is a block diagram of a terminal and a server according to an embodiment of the present disclosure. FIG. 3A to 3C are diagram illustrating terminals of various sizes according to an embodiment of the present disclosure.

As illustrated in FIGS. 1 to 3C, a system 100 for managing vehicle quality may include a terminal 110, a server 120, and a database 130 connected to the server 120, and the terminal 110 and the server 120 may be connected to a private LTE network 10, any combination of or all of which may be in plural or may include plural components thereof. In the present disclosure, the terminal 110 and the server 120 are illustrated as connected through the private LTE network 10, but this is not necessarily limited to the private LTE network 10 described above, for example where security may be improved.

The terminal 110 and the server 120 for managing vehicle quality described above may include a processor (e.g., a computer, a microprocessor, a CPU, an ASIC, a logic circuit, or the like) and a memory storing software instructions which provide the above-described functions when executed by the processor. Here, the processor and memory may be implemented as separate semiconductor circuits. Alternatively, the processor and the memory may be implemented as a single integrated semiconductor circuit. A processor can be one or more processors, together or separated.

Hereinafter, the terminal 110 and the server 120 will be described in detail.

The terminal 110 may be a device for displaying an inspection item according to a process for managing vehicle quality, receiving data relating to the displayed inspection item, and transmitting a process name of the process for managing vehicle quality, the data relating to the inspection item, and an identification number of the vehicle to the server 120.

The above-mentioned process for managing vehicle quality can be a process for various inspections for a vehicle in a completed assembly stage, and may include an inspection process and a correction process. The inspection process may include at least one of a performance inspection process, a specification inspection process, an appearance inspection process, and an assembly inspection process, and the correction may be provided for each process of the inspection process.

According to an embodiment of the present disclosure, the terminal 110 may have different specifications depending on the characteristics of the process for managing vehicle quality, and may be provided for each inspection process and/or each correction process.

The characteristic of the above-described quality control process may include at least one of the number of inspection items and whether it is necessary to board a vehicle for inspection or correction, and the specifications may include a screen size of the terminal 110 and whether the terminal 110 is portable.

For example, when there are many inspection items, such as during the specification inspection process, or the like, so more than a preset number of inspection items can be displayed on one screen, a portable terminal with a first screen size (e.g., 8.7 inches) may be used (see FIG. 3B).

For example, in an example case of a process such as during the performance inspection process, or the like, in which an operator boards a vehicle frequently, the operator may only need to check the process part of the operator himself, and portability of a terminal may be preferred or required, and a terminal with a second screen size (e.g., 6.6 inches) smaller than the first screen size may be used (see (FIG. 3A).

For example, when the work is performed while holding a work tool in one's hand, such as during the correction process, it can be difficult to hold a terminal, so a fixed terminal installed at a fixed location may be used. A screen size of such a fixed terminal may have a large screen size, for example, 21.5 inches (see FIG. 3C).

The terminal 110 may be an inspection terminal used in an inspection process or a correction terminal used in a correction process.

Such a terminal 110 may include an input/output unit 111, a control unit 112, a storage unit 113, and a communication unit 114, any combination of or all of which may be in plural or may include plural components thereof. The above-described terminal 110 may include a smart phone, a cell phone, a personal digital assistant (PDA), a touchscreen PC, a tablet personal computer, a laptop, and the like, for example.

Specifically, the input/output unit 111 may display an inspection item according to the process for managing vehicle quality, and receive data relating to the displayed inspection item.

When the terminal 110 is a terminal for inspection, the data of the inspection item may be result data relating to the inspection item, and when the terminal 110 is a terminal for correction, the data of the inspection item may be correction data relating to the inspection data.

The result data relating to the inspection item may be input manually by an operator or may be entered automatically by receiving inspection result data from an inspection facility (not shown), and the correction data relating to the inspection item may be input manually by the operator.

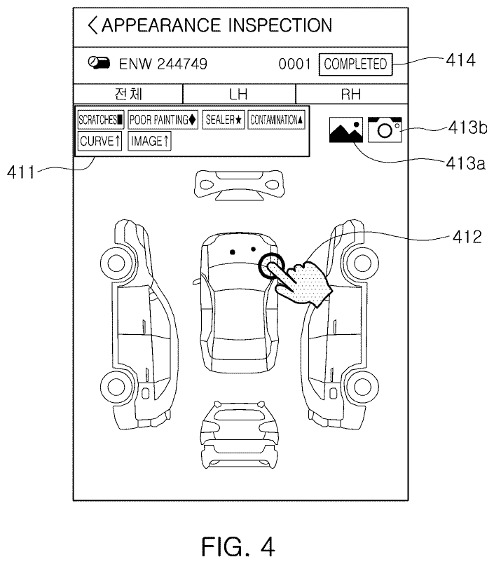

FIG. 4 is a diagram illustrating an inspection item for manually inputting data according to an embodiment of the present disclosure, and illustrates an external inspection during the inspection process.

As illustrated in FIG. 4, an inspection item 411 can be displayed through an input/output unit 111, and an operator may touch a specific item (e.g., scratch) among the displayed inspection items 411, and touch 412 the exterior of the vehicle to input the inspection result data. Thereafter, when a completion button 414 is pressed, a process name of a process for managing vehicle quality, data of inspection times, and an identification number of the vehicle may be transmitted to a server 120. If necessary, a previously saved file may be attached by pressing a load button 413a, or may be attached by capturing an image of the necessary part and pressing an image capture button 413b.

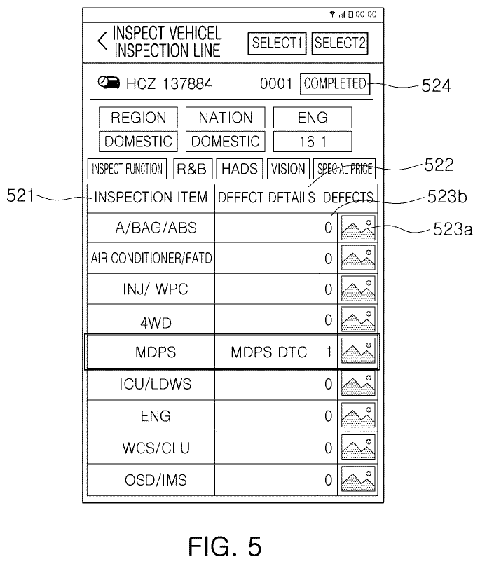

FIG. 5 is a diagram illustrating an inspection item into which data is automatically input according to an embodiment of the present disclosure, and illustrates a performance inspection (vehicle inspection line) during the inspection process.

As shown in FIG. 5, an inspection item 521 may be displayed through the input/output unit 111, and data from inspection results from an inspection facility (not shown), i.e., details on defects 522, the number of defects 523a may be input automatically. Thereafter, when a completion button 524 is pressed, the process name of the process for managing vehicle quality, the data of the inspection item, and the identification number of the vehicle may be transmitted to the server 120. If necessary or desired, a previously saved file can be attached by pressing a load button 523b.

The control unit 112 may transmit the process name of the process for managing vehicle quality, the data of the inspection item, and the identification number of the vehicle externally through the communication unit 114, as described more below.

Although only a portion of the inspection process is described in FIGS. 4 and 5, other operations can be applied in a similar manner for the remaining inspection processes and correction processes.

The control unit 112 may receive operator login information (e.g., ID and password) through the input/output unit 111, transmit the received operator login information to the server 120, and perform the above-described operation when the operator is authenticated according to authentication results from the server 120. In the present disclosure, ID and password are exemplified as login information, but biometric information such as fingerprint, iris pattern, and the like, can also be used as login information.

The control unit 112 can inquire the identification number of the vehicle with the server 120 through the communication unit 114, and in this example case, by receiving the process name of the process for managing vehicle quality currently being performed on the vehicle from the server 120, a current location of the vehicle may also be tracked in real time.

The storage unit 113 may store various programs and data to implement the functions performed by the control unit 112 described above.

The communication unit 114 may transmit and receive various data with the server 120 under the control of the control unit 112.

The server 120 may include a communication unit 121, a control unit 122, a storage unit 123, and an output unit 124, any combination of or all of which may be in plural or may include plural components thereof.

The communication unit 121 may transmit and receive various data with the terminal 110 under the control of the control unit 122.

The control unit 122 may receive a process name of the process for managing vehicle quality, data of an inspection item according to a process for managing vehicle quality, and an identification number of the vehicle from the terminal 110, and store the process name of the process for managing vehicle quality, the data of the inspection item according to the process for managing vehicle quality, and the identification number of the vehicle in the database 130.

The control unit 122 may transmit and update the process name of the current process for managing vehicle quality, the data relating to the inspection item according to the current process for managing vehicle quality, and the identification number of the vehicle to another terminal for performing another process for managing vehicle quality other than the current process for managing vehicle quality, thereby sharing the current process for managing vehicle quality of the vehicle with other terminals in real time.

The control unit 122 may receive operator login information from the terminal 110, authenticate the operator based on the received operator login information, and transmit the authentication result to the terminal 110. The control unit 122 may store the operator login information in the database 130, described more below, so that history may be checked when defects occur and a sense of operator responsibility may be increased.

The control unit 122 may output a warning through the output unit 124 for a vehicle in which at least one piece of data for an inspection item is defective when signing off. Sign-off can refer to sending a vehicle that has completed quality inspection to a waiting area for finished vehicles.

When an identification number of the vehicle received from the terminal 110 is inquired, the control unit 122 may transmit the process name of the process for managing vehicle quality currently being performed on the vehicle to the terminal 110 based on the identification number of the vehicle, so that it is possible to determine a real-time location of the vehicle.

The storage unit 123 may store various programs and data to implement the functions performed by the control unit 122 described above.

Under the control of the control unit 122, the output unit 124 may output a warning for a vehicle in which at least one piece of data for an inspection item is defective when signing off. This output unit 124 may be, for example, a display, a speaker, a warning light, or a combination thereof.

The database 130 can store various information.

The database 130 may include a specification database including specification information regarding a vehicle, an inspection item database including an inspection item, result data, and correction data for each process in the process for managing vehicle quality, an operator information database including operator login information of the operator who performed work during each operation in the process for managing vehicle quality, and a database storing identification information of a vehicle and a process name of the process for managing vehicle quality, currently being performed on the vehicle.

As described above, according to an embodiment of the present disclosure, by using a terminal, an inspection item according to the process for managing vehicle quality of a vehicle may be displayed, and data relating to the displayed inspection item may be received and transmitted externally, and using a terminal having different specifications according to the characteristics of the process for managing vehicle quality, compared to the existing method using an electronic pen and paper made of a special material, the problem of lower recognition rate may be solved, and also, the system is easy to be maintained, and work efficiency may be improved considering the characteristics of the process for managing vehicle quality.

According to an embodiment of the present disclosure, communication stability and security can be improved by using a private LTE network.

According to an embodiment of the present disclosure, by separately storing operator login information of the operator who performed the process for managing vehicle quality of a vehicle, it is possible to check the history when defects occur and increase a sense of operator responsibility.

According to an embodiment of the present disclosure, it is possible to prevent a defective vehicle from being shipped by outputting a warning for a vehicle in which at least one piece of data on an inspection item is defective when signing off.

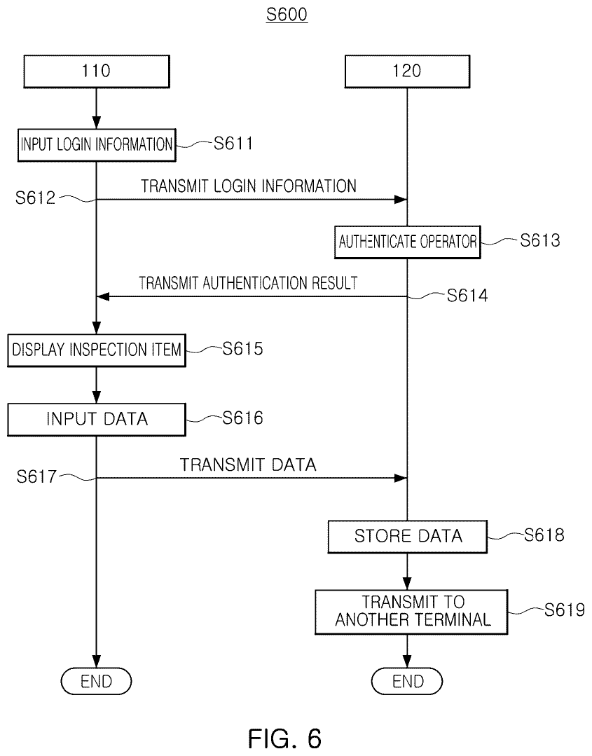

FIG. 6 is a flowchart explaining a method for managing vehicle quality according to an embodiment of the present disclosure.

Hereinafter, a method for managing vehicle quality according to an embodiment of the present disclosure will be described with reference to FIGS. 1 to 6. However, for simplification of the present disclosure, descriptions overlapping with FIGS. 1 to 5 may be omitted.

Referring to FIGS. 1 to 6, a method for vehicle quality (flowchart S600) according to an embodiment of the present disclosure may start by inputting operator login information to a terminal 110 (operation S611).

The input operator login information may be transmitted to a server 120 (operation S612).

Thereafter, the server 120 may authenticate an operator based on the received operator login information (operation S613) and transmit an authentication result to the terminal 110 (operation S614). As described above, the operator login information may be stored in a database 130.

Next, the terminal 110 may display an inspection item according to a process for managing vehicle quality (operation S615), and receive data relating to the displayed inspection item (operation S616).

The above-described process for managing quality can be a process for various inspections of a vehicle in the completed assembly step, and may include an inspection process and/or a correction process. The inspection process may include at least one of a performance inspection process, a specification inspection process, an appearance inspection process, and an assembly inspection process, and the correction process may be provided for each process of the inspection process.

According to an embodiment of the present disclosure, the terminal 110 may have different specifications depending on the characteristics of the process for managing vehicle quality, and may be provided for each of the inspection processes and/or each of the correction processes.

The characteristics of the process for managing vehicle quality described above may include at least one of a set of inspection items and whether it is specified/preferred/necessary to board a vehicle for inspection or correction, and the specifications may include a screen size of the terminal 110 and whether the terminal 110 is portable.

According to an embodiment of the present disclosure, the terminal 110 may include a terminal for inspection used in an inspection process and a terminal for correction used in a correction process.

When the terminal is a terminal for inspection, data of an inspection item may be result data relating to the inspection item, and when the terminal is a terminal for correction, the data of the inspection item may be correction data relating to the inspection item.

As described above, the data relating to the inspection item may be input manually by an operator or may be input automatically by receiving the data of the inspection result from an inspection facility.

Thereafter, the terminal 110 may transmit a process name of a process for managing vehicle quality, data relating to an inspection item, and an identification number of a vehicle to a server 120 (operation S617).

Thereafter, the server 120 may store the process name of the process for managing vehicle quality, the data relating to the inspection item, and the identification number of the vehicle transmitted from a terminal in a database 130 (operation S618).

The server 120 may transmit the process name of the process for managing vehicle quality, the data relating to the inspection item, and the identification number of the vehicle to another terminal (operation S619). Another terminal may share the process for managing vehicle quality with other terminals in real time by updating the data relating to the inspection item according to the process for managing vehicle quality based on data relating to the inspection item.

According to an embodiment of the present disclosure, as described above, the server 120 may output a warning through an output unit 124 for a vehicle in which at least one piece of data for an inspection data is defective when signing off.

When the server 120 inquires the identification number of the vehicle received from the terminal 110, as described above, it can be possible to determine a location of the vehicle in real time, by transmitting the process name of the process for managing vehicle quality, currently being performed for the vehicle based on the identification number of the vehicle.

As described above, according to an embodiment of the present disclosure, by using a terminal, an inspection item may be displayed according to a process for managing vehicle quality and data relating to the displayed inspection item may be received and transmitted externally, and using a terminal having different specifications depending on the characteristics of the process for managing vehicle quality, the problem of lower recognition rate may be solved and at the same time, the system is easy to be maintained, as compared to the existing method of using an electronic pen and paper made of a special material, and work efficiency can be improved by considering the characteristics of the process for managing vehicle quality.

According to an embodiment of the present disclosure, communication stability and security may be improved by using a private LTE network.

According to an embodiment of the present disclosure, by separately storing operator login information of the operator who performed the process for managing vehicle quality, it can be possible to check the history when defects occur and increase a sense of operator responsibility.

According to an embodiment of the present disclosure, it can be possible to prevent defective vehicles from being shipped by outputting a warning for vehicles in which at least one of data on an inspection item is defective when signing off.

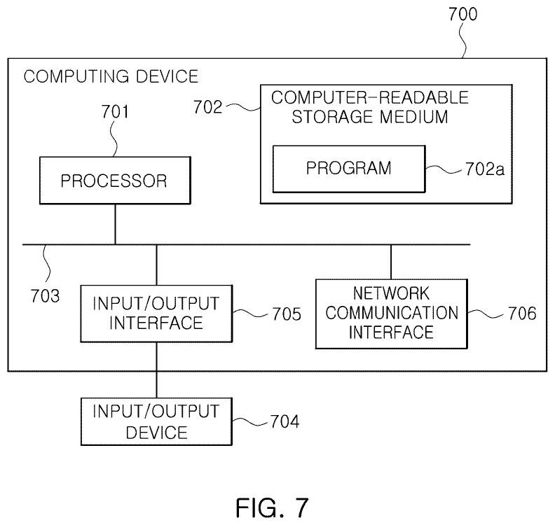

FIG. 7 is a block diagram of a computing device 700 capable of fully or partially implementing a terminal and a server for quality control of vehicles according to an embodiment of the present disclosure.

As illustrated in FIG. 7, the computing device 700 includes at least one processor 701, a computer-readable storage medium 702, and a communication bus 703, any combination of or all of which may be in plural or may include plural components thereof.

The processor 701 may cause the computing device 700 to operate according to the above-described example embodiments. For example, the processor 701 may execute one or more programs store in the computer-readable storage medium 702. The one or more programs may include one or more computer executable instructions, where, when executed by the processor 701, the computer-readable executable instructions may be configured to cause the computing device 700 to perform operations according to an example embodiment.

The computer-readable storage medium 702 can be configured to store computer-executable instructions or program code, program data, and/or other suitable forms of information. A program 702a stored on the computer-readable storage medium 702 can include a set of instructions executable by the processor 701. In an embodiment, the computer-readable storage medium 702 may include a memory (a volatile memory such as a random access memory, a non-volatile memory, or a suitable combination thereof), one or more magnetic disk storage devices, optical disk storage devices, flash memory devices, other forms of storage media that can be accessed by the computing device 700 and store desired information, or suitable combinations thereof.

The communication bus 703 can interconnect various other components of the computing device 700, including the processor 701 and the computer-readable storage medium 702.

The computing device 700 may also include one or more input/output interfaces 705 and one or more network communication interfaces 706 providing an interface for one or more input/output devices 704. The input/output interface 705 and the network communication interface 706 can be connected to the communication bus 703. The network may be either a cellular network, such as a global system for mobile communications (GSM), enhanced data rates for GSM evolution (EDGE), a general packet radio service (GPRS), a code division multiple access (CDMA), a time division CDMA (TD-CDMA), a universal mobile telecommunications system (UMTS), a long term evolution (LTE), or another cellular network, for example.

The input/output device 704 may be connected to other components of the computing device 700 through the input/output interface 705. The example input/output device 704 may include an input device such as a pointing device (a mouse, a trackpad, or the like), a keyboard, a touch input device (a touchpad, a touchscreen, or the like), a voice or sound input device, various types of sensor devices, and/or a photographing device, and an output device such as a display device, a printer, a speaker, and/or a network card. The example input/output device 704 may be included inside the computing device 700 as a component constituting the computing device 700, or may be connected to the computing device 700 as a separate device, distinct from the computing device 700.

Embodiments of the present disclosure may include a program for performing the methods described in this specification on a computer, and a computer readable recording medium including the program. The computer-readable recording medium may include program instructions, local data files, local data structures, or the like, alone or in a combination thereof. The medium may be specially designed and configured for the present disclosure, or may be commonly available in the field of computer software. Examples of the computer-readable medium may include a hardware device specially configured to store a magnetic medium such as hard disks, floppy disks and magnetic tapes, an optical recording medium such as CD-ROMs and DVDs, and program instructions such as ROM, RAM, and a flash memory and perform the same. Examples of the program may include not only machine language codes generated by a compiler, but also high-level language codes that may be executed by a computer using an interpreter.

As set forth above, according to an embodiment of the present disclosure, by using a terminal, inspection items according to a process for managing vehicle quality may be displayed, data of the displayed inspection items can be received and transmitted externally, and by using a terminal with different specifications depending on the characteristics of the process for managing vehicle quality of a vehicle, the problem of low recognition rate may be solved as compared to the existing method of using an electronic pen and paper made of a special material, and at the same time, the system is easy to be maintained.

According to an embodiment of the present disclosure, communication stability and security may be improved by using a private LTE network.

According to an embodiment of the present disclosure, by separately storing operator login information of the operator who performed a process for managing vehicle quality, a history when defects occur may be checked, and a sense of operator responsibility may be increased.

According to an embodiment of the present disclosure, it can be possible to prevent defective vehicles from being shipped by outputting a warning for a vehicle in which at least one piece of data relating to an inspection item is defective when signing off.

The present disclosure is not limited to the above-described example embodiments and the accompanying drawings and can be defined by the appended claims. Therefore, those of ordinary skill in the art may make various replacements, modifications, or changes without departing from scopes of the present disclosure defined by the appended claims, and these replacements, modifications, or changes can be determined by those of ordinary skill in the art.

What is claimed is:

1. A terminal system for managing vehicle quality, comprising one or more terminals, wherein each terminal comprises:
one or more processors; and
a non-transitory storage medium storing computer-readable instructions
that, when executed by the one or more processors, enable the one or more processors to:
generate a display for an inspection item according to a given process for managing vehicle quality,
receive data corresponding to the display of the inspection item, and
transmit externally a process name of the given process for managing vehicle quality, and the data of the inspection item, and an identification name of a vehicle,
wherein each of the one or more terminals has specifications depending on characteristics of the given process for managing vehicle quality.

2. The system of claim 1, wherein the given process for managing vehicle quality comprises at least one of or any combination of:
an inspection process including at least one of or any combination of a performance inspection process, a specification inspection process, an appearance inspection process, and an assembly inspection process; and
a correction process for at least one of or any combination of the performance inspection process, the specification inspection process, the appearance inspection process, and the assembly inspection process,
wherein the terminal is provided for each of the inspection process and the correction process.

3. The system of claim 2, wherein the one or more terminals comprises:
an inspection terminal for inspection used in the inspection process; and
a correction terminal for correction used in the correction process.

4. The system of claim 3, wherein for the inspection terminal, the data of the inspection item is result data relating to the inspection item, and
wherein for the correction terminal, the data of the inspection item is correction data relating to the inspection item.

5. The system of claim 1, wherein the instructions further enable the one or more processors to, in response to the one or more processors receiving operator login information for an operator, transmit the received operator login information externally,
receive an authentication result of the operator from an external source, and
operate in response to the operator being authenticated according to the authentication result.

6. The system of claim 1, wherein the data of the inspection item is input manually by an operator or automatically input by receiving inspection result data from inspection equipment.

7. The system of claim 1, wherein the characteristics of the given process for managing quality comprises
at least one of a set of the inspection items and whether boarding a vehicle for inspection or modification is specified, and wherein
the specifications include portable capability specification and a terminal screen size.

8. The system of claim 7, wherein the one or more terminals comprises:
a first portable terminal having a first screen size preset to display a preset number or more of the inspection items;
a second portable terminal having a second screen size, the second screen size being smaller than the first screen size, preset to display less than the preset number of the inspection items; and
a fixed terminal installed in a fixed location.

9. The system of claim 1, wherein the one or more terminals are connected to a private LTE network.

10. The system of claim 1, wherein the instructions further enable the one or more processors to:
transmit an identification number of the vehicle to an external server, and
receive from the external server a process name of the given process for managing vehicle quality being performed on the vehicle based on the identification number.

11. A server for managing vehicle quality, comprising:
one or more processors; and
a non-transitory storage medium storing computer-readable instructions that, when executed by the one or more processors, enable the one or more processors to:
receive a process name of a first process for managing vehicle quality, data of an inspection item according to the first process for managing vehicle quality, and an identification number of a vehicle from a first terminal,
store the process name of the first process for managing vehicle quality, the data of the inspection item, and the identification number of the vehicle, and
transmit the process name of the first process for managing vehicle quality, the data of the inspection item, and the identification number of the vehicle to a second terminal for performing a second process for managing vehicle quality different than the first process for managing vehicle quality,
wherein the first terminal has different specifications than the second terminal based on characteristics of the second process for managing vehicle quality being different than the first process for managing vehicle quality.

12. The server of claim 11, wherein the first process for managing vehicle quality comprises at least one of or any combination of:
an inspection process including at least one of or any combination of a performance inspection process, a specification inspection process, an appearance inspection process, and an assembly inspection process; and
a correction process for at least one of or any combination of the performance inspection process, the specification inspection process, the appearance inspection process, and the assembly inspection process.

13. The server of claim 11, wherein the instructions further enable the one or more processors to:
receive operator login information for an operator;
authenticate the operator based on the received operator login information of the operator to generate an authentication result; and
transmit externally the authentication result.

14. The server of claim 13, wherein the instructions further enable the one or more processors to store the operator login information.

15. The server of claim 11, wherein the server is connected to a private LTE network.

16. The server of claim 11, further comprising
a database for managing quality, wherein the database for managing quality comprises:
a specification database including specification information for the vehicle;
an inspection item database including inspection items, result data, and correction data for each process in the first process for managing vehicle quality;
an operator information database including operator login information of an operator who performed work during each process in the first process for managing vehicle quality; and
a database storing identification information of the vehicle and a process name of the first process for managing vehicle quality being performed on the vehicle.

17. The server of claim 16, wherein the instructions further enable the one or more processors to
transmit a process name of the process for managing vehicle quality being performed on the vehicle based on an identification number received from an external source.

18. The server of claim 11, wherein the instructions further enable the one or more processors to output a warning regarding a vehicle in which at least one piece of data for an inspection item is defective when signing off through an output device.

19. A method for managing vehicle quality, comprising:
displaying on a first terminal an inspection item according to a first process for managing vehicle quality;
receiving data on the first terminal corresponding to the inspection item;
transmitting from the first terminal to a server a process name of the first process for managing vehicle quality, the data of the inspection item, and an identification number of a vehicle;
storing, in the server, the process name of the first process for managing vehicle quality, the data of the inspection item, and the identification number of the vehicle from the first terminal;
transmitting from the server to a second terminal, the process name of the first process for managing vehicle quality, the data of the inspection item, and the identification number of the vehicle for performing a second process for managing vehicle quality different than the first process for managing vehicle quality; and
updating, in the second terminal, the data of the inspection item according to the second process for managing vehicle quality, wherein the second terminal has different specifications than the first terminal based on characteristics of the second process for managing vehicle quality being different than the first process for managing vehicle quality.

20. The method of claim 19, wherein the first process for managing vehicle quality comprises at least one of or any combination of:
an inspection process including at least one of or any combination of a performance inspection process, a specification inspection process, an appearance inspection process, and an assembly inspection process; and
a correction process for at least one of or any combination of the performance inspection process, the specification inspection process, the appearance inspection process, and the assembly inspection process.
